(19) United States
(12) Patent Application Publication
(10) Pub. No.: US 2014/0181205 A1
(43) Pub. Date: Jun. 26, 2014

(54) PROMOTING SHARING IN A SOCIAL NETWORK SYSTEM

(71) Applicant: Google Inc., Mountain View, CA (US)

(72) Inventors: Doug Sherrets, New York, NY (US); Scott Robert McMullan, Palo Alto, CA (US); Daniel Burka, San Francisco, CA (US)

(21) Appl. No.: 14/140,433

(22) Filed: Dec. 24, 2013

Related U.S. Application Data
(60) Provisional application No. 61/746,117, filed on Dec. 26, 2012.

(51) Int. Cl. H04L 29/06

(52) U.S. Cl. CPC H04L 65/403
USPC 709/204

(57) ABSTRACT

Implementations generally relate to promoting sharing in a social network system. In some implementations, a method includes receiving one or more media items in a social network, where the one or more media items are associated with a location. The method also includes detecting a post, where content in the post references the location. The method also includes providing a suggestion to a user to share the one or more media items in the post.

### CROSS REFERENCE TO RELATED APPLICATIONS

This application claims priority from U.S. Provisional Patent Application No. 61/746,117 entitled “PROMOTING SHARING IN A SOCIAL NETWORK SYSTEM,” filed Dec. 26, 2012, which is hereby incorporated by reference as if set forth in full in this application for all purposes.

### BACKGROUND

Social network systems often enable users to share various media items such as photos. After a user uploads media items such as photos to a social network system, the social network system typically enables the user to include the photos in one or more photo albums. The social network system typically enables the user to share one or more photos with other users of the social network system. For example, a user may attach one or more photos to a message that the user posts to other users.

### SUMMARY

Implementations generally relate to promoting sharing in a social network system. In some implementations, a method includes receiving one or more media items in a social network, where the one or more media items are associated with a location. The method also includes detecting a post, where content in the post references the location. The method also includes providing a suggestion to a user to share the one or more media items in the post.

With further regard to the method, in some implementations, the one or more media items include one or more of photos, images, graphics, videos, and audio tracks. In some implementations, the one or more media items are associated with the location by geotags. In some implementations, the location is a business location. In some implementations, the method further includes analyzing the content in the post, and identifying a reference to the location in the content in the post. In some implementations, the providing of the suggestion includes providing a prompt to share the one or more media items, causing the one or more media items to be displayed to the user, and enabling the user to select the one or more media items to include in the post. In some implementations, the providing of the suggestion is based on predetermined criteria. In some implementations, the providing of the suggestion is based on predetermined criteria associated with geographic radius. In some implementations, the providing of the suggestion is based on predetermined criteria associated with one or more social signals. In some implementations, the providing of the suggestion is based on predetermined ranking criteria. In some implementations, the providing of the suggestion is based on predetermined image recognition criteria.

In some implementations, a method includes receiving one or more media items in a social network, where the one or more media items are associated with a location. The method further includes detecting a post, where content in the post references the location. The method further includes analyzing the content in the post. The method further includes identifying a reference to the location in the content in the post. The method further includes providing a suggestion to a user to share the one or more media items in the post, where the providing of the suggestion is based on predetermined criteria.

With further regard to the method, in some implementations, the one or more media items include one or more of photos, images, graphics, videos, and audio tracks. In some implementations, the one or more media items are associated with the location by geotags. In some implementations, the providing of the suggestion includes providing a prompt to share the one or more media items, causing the one or more media items to be displayed to the user, and enabling the user to select the one or more media items to include in the post.

In some implementations, a system includes one or more processors, and logic encoded in one or more tangible media for execution by the one or more processors. When executed, the logic is operable to perform operations including: receiving one or more media items in a social network, where the one or more media items are associated with a location; detecting a post, where content in the post references the location; and providing a suggestion to a user to share the one or more media items in the post.

With further regard to the system, in some implementations, the one or more media items include one or more of photos, images, graphics, videos, and audio tracks. In some implementations, the one or more media items are associated with the location by geotags. In some implementations, the location is a business location. In some implementations, the logic when executed is further operable to perform operations including analyzing the content in the post, and identifying a reference to the location in the content in the post.

### BRIEF DESCRIPTION OF THE DRAWINGS

FIG. 1 illustrates a block diagram of an example network environment, which may be used to implement the implementations described herein.

FIG. 2 illustrates an example simplified flow diagram for promoting sharing in a social network system, according to some implementations.

FIG. 3 illustrates an example simplified user interface, according to some implementations.

FIG. 4 illustrates an example simplified user interface, according to some implementations.

FIG. 5 illustrates a block diagram of an example server device, which may be used to implement the implementations described herein.

### DETAILED DESCRIPTION

Implementations described herein promote sharing in a social network system. In various implementations, a system receives one or more media items from a user in a social network system, where the one or more media items are associated with a location. In some implementations, the one or more media items may include a variety different types of media. For example, media items may include photos, images, graphics, videos, audio tracks, etc. In some implementations, the one or more media items are associated with the location by geotags.

The system then detects a post being generated by the user, where content in the post references the location. In some implementations, the location is a geographic location (e.g., a specific place, a city, etc.). In some implementations, the system analyzes the content in the post, and identifies a reference to the location in the content in the post.

The system then provides a suggestion to the user to share the one or more media items in the post. In some implementations, the system provides a prompt to share the one or more media items, causes the one or more media items to be displayed to the user, and enables the user to select the one or more media items to include in the post. In some implementations, the system provides the suggestion to the user based on predetermined criteria. The predetermined criteria may be associated with one or more of geographic radius and one or more social signals.

Implementations described herein increase user engagement in a social network by facilitating users in sharing media items. For example, a user may conveniently add images or videos to posts.

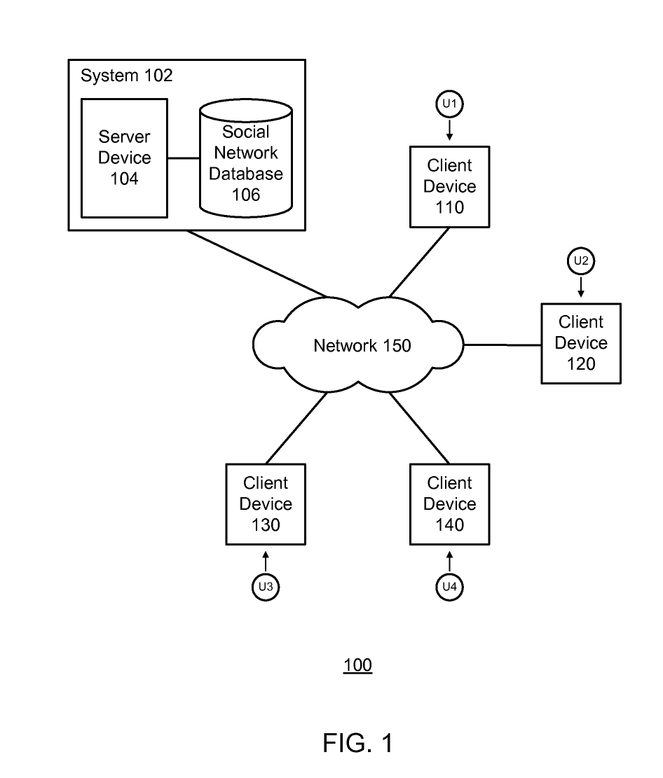

FIG. 1 illustrates a block diagram of an example network environment 100, which may be used to implement the implementations described herein. In some implementations, network environment 100 includes a system 102, which includes a server device 104 and a social network database 106. The term system 102 and phrase “social network system” may be used interchangeably. Network environment 100 also includes client devices 110, 120, 130, and 140, which may communicate with each other via system 102 and a network 150.

For ease of illustration, FIG. 1 shows one block for each of system 102, server device 104, and social network database 106, and shows four blocks for client devices 110, 120, 130, and 140. Blocks 102, 104, and 106 may represent multiple systems, server devices, and social network databases. Also, there may be any number of client devices. In other implementations, network environment 100 may not have all of the components shown and/or may have other elements including other types of elements instead of, or in addition to, those shown herein.

In various implementations, users U1, U2, U3, and U4 may communicate with each other using respective client devices 110, 120, 130, and 140. For example, users U1, U2, U3, and U4 may interact with each other by sharing posts, media items such as photos, etc.

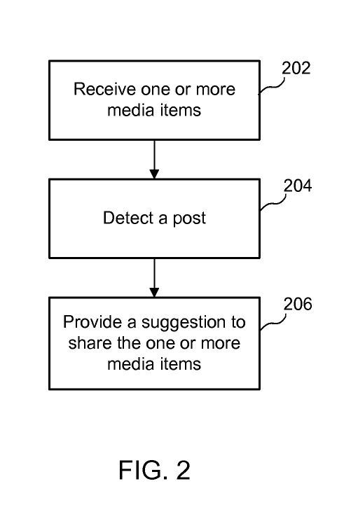

FIG. 2 illustrates an example simplified flow diagram for promoting sharing in a social network system. Referring to both FIGS. 1 and 2, a method is initiated in block 202, where system 102 receives one or more media items in a social network system, where the one or more media items are associated with a location. In various implementations, the one or more media items may include photos. In some implementations, the one or more media items may be associated with the location by geotags.

For ease of illustration, some implementations are described herein in the context of photo media items. Such implementations also apply to other types of media items. For example, in various implementations, media items may also include but are not limited to photos, images, graphics, videos, audio tracks, gifs, documents, event information, emails, messages, posts, comments, responses, tags, group join requests, group join acceptances, geographic and/or location information, etc. The types of media items will vary depending on particular implementation.

In block 204, system 102 detects a post. In various implementations, system 102 detects outbound posts (e.g., posts being generated) and/or inbound posts (e.g., posts being received). For example, system 102 may detect a post as it is being generated by a sending user. System 102 may also detect a post as it is received by a recipient user.

In some implementations, system 102 identifies all posts by the sending user as the posts are being generated. In some implementations, system 102 identifies all posts by friends, and analyzes social affinity between each friend and the recipient user.

System 102 may analyze all photos for geotags and topics. Topics may include words used in the title and/or description of a photo and/or album (e.g., location, city name, country, etc.). In some implementations, system 102 may identify where a given user tends to be, based on geotags (e.g., in town of residence, etc.).

In various implementations, content in the post references the location. In various implementations, the types of locations may vary, depending on the specific implementation. For example, the location may be a geographic location. The location may also be a business location. In some implementations, system 102 may analyze the content in a given post, and then identify a reference to the location in the content in the post.

For ease of illustration, some implementations are described herein in the context of media items and posts associated with a single user. Such implementations also apply to multiple users, depending on the particular implementations. For example, in various implementations, system 102 may analyze photos (e.g., multiple photos from multiple users) associated with different geotags and topics.

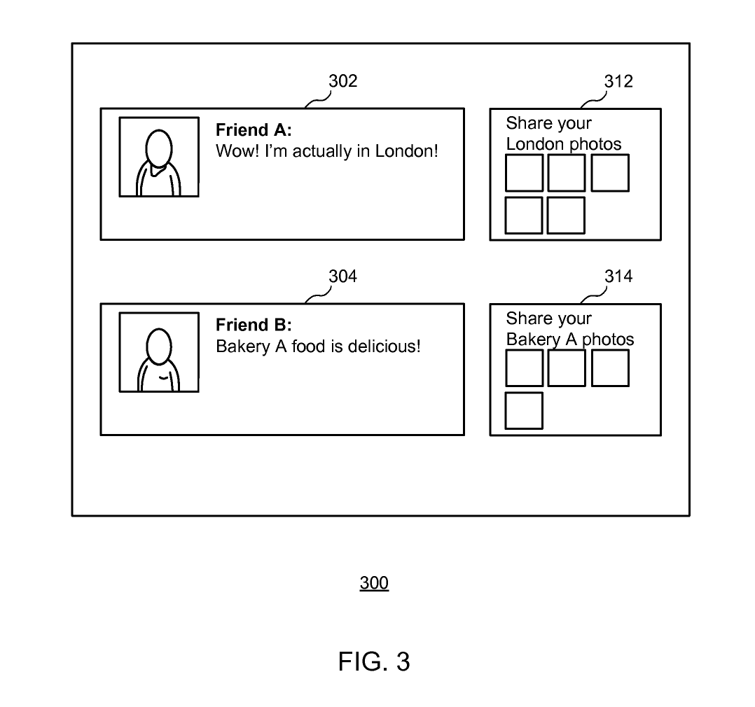

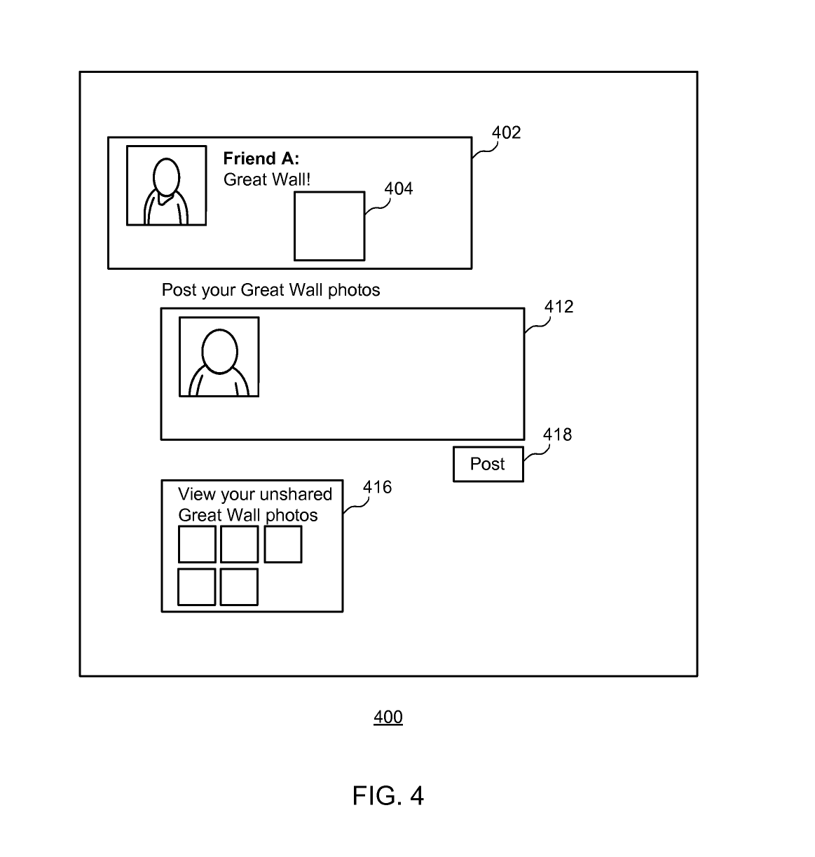

In block 206, system 102 provides a suggestion to share the one or more media items. In some implementations, to provide a suggestion, system 102 may provide a prompt to share the one or more media items, cause the one or more media items to be displayed to the user, and then enable the user to select the one or more media items to include in the post. For example, if the recipient user receives a post from a friend where the post references London, system 102 may suggest that the recipient user share the recipient user's own photos of London. Example implementations are described in more detail below in connection with FIGS. 3 and 4.

In various implementations, system 102 may provide suggestions based on predetermined criteria. For example, system 102 may provide one or more suggestions based on predetermined criteria associated with geographic radius. System 102 may also provide one or more suggestions based on predetermined criteria associated with one or more social signals.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

While system 102 is described as performing the steps as described in the implementations herein, any suitable component or combination of components of system 102 or any suitable processor or processors associated with system 102 may perform the steps described.

FIG. 3 illustrates an example simplified user interface 300, according to some implementations. As shown, user interface 300 shows posts 302 and 304, which represent a feed of updates by friends. User interface 300 also shows suggestions 312 and 314 that the user share some photos that the user captured at the place the friends are visiting. As indicated above, system 102 may identify these photos based on geotags. For example, post 302 references London. Accordingly, suggestion 312 suggests sharing London photos. Similarly, post 304 references Bakery A. Accordingly, suggestion 314 suggests sharing Bakery A photos.

The user may select one or more photos to share in a variety of ways, depending on the specific implementations. For example, in various implementations, the user may tap on a portion of the suggestion to indicate which photos to share (e.g., tapping on one or more photos). In some implementations, the user may tap on a portion of the suggestion to indicate that certain photos or albums not be presented for suggestions again. Photos may be shared as comments on friends posts, shared privately, shared as a new post with any privacy settings, etc.

FIG. 3 illustrates an example where system 102 enables a recipient of posts to share photos associated with the recipient, where the photos may be relevant to the posts (e.g., associated with a common location). Other variations are possible. For example, when a given user generates a post that references a location, system 102 may prompt that user to share photos having geotags that match the location. This facilitates the user in sharing while generating posts.

FIG. 4 illustrates an example simplified user interface 400, according to some implementations. As shown, user interface 400 shows a post 402 from a friend. Post 402 includes a photo 404 (e.g., Great Wall of China) that is geotagged. Also shown is a comment box 412 for the recipient of post 402 to post a comment and one or more Great Wall photos 416. As described herein, system 102 may suggest photos based on various predetermined criteria. For example, system 102 may base suggestions on geotags ranging from a specific location to a broader region such as across an entire country.

In various implementations described herein, system 102 may provide suggestions based on predetermined ranking criteria. In some implementations, tapping the suggestions may include sorting suggested photos based on ranking, as well as by geotag and time. In some implementations, user interface 400 may display a map showing photos to share, where the map helps the user to identify where particular photos were captured (e.g., a city view map of places/areas/streets visited, etc.). In various implementations, system 102 may enable the user to post one or more selected photos with a one-click share option button 418. With any of the implementations described herein (e.g., FIG. 3, FIG. 4, etc.), system 102 enables a given user to indicate which other users may view shared photos, and with what level of prominence (e.g., as posts, as messages, as notifications, etc.).

As described herein in various implementations, system 102 may analyze geotags of photos, access a list of updates/posts that are shared among users, then match the locations between those of the geotags and those referenced in the updates. System 102 may give a highest confidence when matching a geotag within a given radius with another geotag. Geotags of specific places may be most prominently surfaced (e.g., identified), while geotags of cities are less prominently surfaced until they are places that are relatively far away (e.g., from the user's residence) and that have not been visited frequently.

As indicated above, in various implementations, system 102 may provide suggestions based on predetermined ranking criteria. The following example implementations are directed to matching and ranking locations associated with media items (e.g., photos) and with posts. As indicated above, system 102 may provide suggestions based on other types of predetermined criteria. For example, system 102 may provide one or more suggestions based on predetermined criteria associated with geographic radius, associated with one or more social signals, etc.

In some implementations, system 102 may match posts based on social affinity of particular users. System 102 may also match posts based on a variety of aspects such as by geotags in attached photos, topics or keywords associated with attached photos, topics or keywords referenced in a post, etc.

In some implementations, system 102 then ranks posts that were matched. For example, system 102 may rank posts based on geotags, social affinity, recency, etc., or any combination thereof. The following are examples of ranking based on geotags. Some examples below are based on a friend, user B, posting something such as a photo, and a user A seeing the post. In various implementations, the location of a given user may be defined narrowly or broadly (e.g., a specific place, neighborhood, city, state, region, country, continent, etc.). Determining whether user A tends to be in a particular location (e.g., resident city) may be based on how many photos user A has geotagged there.

In one scenario, user A is typically in a given location, whereas user B is not typically in that location. In some implementations, system 102 may tend to use a smaller radius when comparing locations (e.g., geotags). For example, user A may live in San Francisco and may typically visit Dolores Park in San Francisco, and user B may have posted about being in Dolores Park.

In another scenario, user A is typically in a given location, and user B is also typically in that same location. System 102 may tend to use a smaller radius when comparing locations, and maybe an even smaller radius than typically in the previous scenario. For example, user A may have posted a photo of the Golden Gate Bridge, and user B may have posted a photo of Alamo Square. Both locations may be in San Francisco but not necessarily close enough to warrant a prominent suggestion, given that both user A and user B post a lot of San Francisco media items and/or content.

In another scenario, user A is typically not in a given location, whereas user B is typically in that location. System 102 may tend to use a larger radius when comparing locations. For example, user B may post a photo of food at a restaurant in the Shoreditch area of London, and user A may have captured a photo from some part of Shoreditch as well as photos of other neighborhoods around Shoreditch and around London. System 102 may provide a suggestion that user A share the Shoreditch photos, as well as share more London photos with user B. In some implementations, after showing this suggestion more than once, system 102 may focus suggestions on photos closer in location to the those referenced in the post, such as Shoreditch, without other photos taken farther away, such as of Parliament.

In another scenario, user A is typically not in a given location, and user B is also typically not in that location. System 102 may cause mobile notification (e.g., vibrating the phone) to user A to share a photo with user B, or vice versa. System 102 may tend to use a larger radius when comparing locations, and perhaps even use a larger radius than typically in the previous scenario. For example, user B from NYC may post about visiting China, and user A may have photos of China that have not been shared yet from 2 years ago. As such, system 102 may cause a suggestion to prominently appear to encourage user A to post photos to share with user B.

The following are examples of ranking based on social affinity. In various implementations, system 102 may vary how prominently system 102 makes suggestions to share in order to encourage more user interaction. For example, in one scenario, a user A typically interacts with user B, and user B typically does not interact with user A. As such, system 102 may prominently feature an interaction (e.g., suggest sharing, etc.).

In another scenario, user A typically interacts with user B, and user B typically interacts with user A. System 102 may also prominently feature an interaction, yet perhaps not as prominently as the previous scenario.

In another scenario, user A typically does not interact with user B, and user B typically interacts with user A. System 102 may feature an interaction less prominently.

In another scenario, user A typically does not interact with user B, and user B typically does not interact with user A. System 102 may feature an interaction less prominently, yet perhaps even less than than the previous scenario, or possibly no promotion/suggestion of sharing at all. These are some examples, and the degree of promotion for each scenario may vary depending on the particular implementations.

The following example implementations are directed to system 102 making suggestions. In some implementations, photos that have not yet been shared are visible only to the owner of the photos. For example, photos of user A may have been automatically saved, and may be visible only to the owner of the photos. As such, system 102 may suggest that user A share one or more of those photos with user B.

In some scenarios, some photos may have been shared, but not with a particular person. For example, user A may have shared photos from a trip to New York with a group of 10 friends, but not with user B. As such, system 102 may suggest that user A share one or more of those photos with user B.

In some implementations, system 102 may check if any suggestions have been made before and adjust the ranking accordingly. System 102 may also adjust rankings based on whether a user has chosen to share at a high rate per impression utilizing a number of factors (e.g., per photo, per album, for a given time, for a given place/city/geolocation, for a given social affinity, for a given geo proximity, and/or for a given geo interaction rate). In some implementations, system 102 may adjust rankings based on if any social affinities have changed recently.

In some implementations, system 102 may enable recipients to choose to stop receiving suggestions for a particular photo, particular album, particular cluster of photos (such as based on time and/or geotag), etc.

With regard to mobile notifications, there might be a push notification to share, in the case of a high ranking suggestion. With regard to stream posts, system 102 may highly rank stream posts based on posts that system 102 believes have relevant and/or interesting content to reply with, including putting the posts at the top of a user's stream. This addresses the problem of seeing posts and not knowing what to say to create fun interaction.

With regard to third-parties, there may be a third-party photo site that shows a photo shared by a friend. System 102 may cause a recommendation for sharing to appear as part of using a widget. In some implementations, system 102 may provide recommendations via browser notifications.

In various implementations, system 102 may enable sharing in a variety of ways. For example, system 102 may enable a user to share media content as a comment. For example, a photo or post may be included as a comment on a post. In some implementations, this may involve using the privacy settings that are included in the post. System 102 may also enable sharing as a new post, where system 102 may include a tag to the person with the original post.

In some implementations, system 102 may enable a given user to share a photo or post with a relevant user-selected group of people, which may be based on the content. For example, a post about food at a restaurant may be shared with a “weekly dinner group.”

In some implementations, system 102 may automatically rank a relevant group of people. Such sharing with people may be based on various factors (e.g., geotags, social affinity, facial recognition, etc.). In various implementations, system 102 may make suggestions based on predetermined image recognition criteria. For example, with user permission, system 102 may analyze faces appearing in photos that have not been shared to determine if a suggestion to share is warranted.

In some implementations, system 102 may provide links that a given user has visited and videos that the given user has watched, where the links and/or videos are associated with topics related to what a friend has posted. For example, user A may see that user B posted a link about a video of New York City weather. System 102 may suggest videos that user A has watched that are related to weather.

In some implementations, system 102 may rank posts that a given user has not yet seen where it appears that the given user would have a reason to contribute something in a reply. In various implementations, rank may be based on a combination of social affinity (e.g., proximity of users, whether users would want to engage) and a rank of suggested content that one user shares with another user. In some implementations, system 102 may rank geotags highest, rank photos/videos next with photos of a user ranked highest in this group, and then rank links. Such ranking may address a possible issue of the user not knowing what to share with another user. For example, birthdays are a good reason to post on someone's wall. In some implementations, when posting for someone's birthday, system 102 may make suggestions to share photos taken one year earlier to show what the user was doing at the time.

In some implementations, system 102 may enable a user to combine multiple photos into one comment or reply, or to select which photos to share, such as in the case of having multiple photos related to a given geotag.

In some implementations, visual suggestions might not appear on a post by default. Rather, system 102 may enable a user to click a link on a post (e.g., “Make a reply suggestion”) in order to see suggestions. Such suggestions may include photos from a year ago or more, or other time period, if available.

In some implementations, system 102 may make suggestions for what a given user may post, where the suggestion may include enabling the given user to view another user's content that is visible publicly. In some implementations, system 102 may enable two or more users, including the user who posted, to share a link to content. Such a link may include a thumbnail of the content/information. In some implementations, system 102 may make suggestions to post about content of other people, such as people who have made comments, in addition to content by the person viewing the content. As such, the user may make new social connections among the user's friends. For example, user A may have a friend user B who has visited Tokyo as well, and user A may post an interesting Tokyo photo that resulted in many comments. This may lead to other users inquiring about the experience to learn more about any of the visits to Tokyo.

In various implementations, system 102 may utilize a variety of recognition algorithms to recognize faces, landmarks, objects, etc. in photos. Such recognition algorithms may be integral to system 102. System 102 may also access recognition algorithms provided by software that is external to system 102 and that system 102 accesses.

In various implementations, system 102 enables users of the social network system to specify and/or consent to the use of personal information, which may include system 102 using their faces in photos or using their identity information in recognizing people identified in photos. For example, system 102 may provide users with multiple selections directed to specifying and/or consenting to the use of personal information. For example, selections with regard to specifying and/or consenting may be associated with individual photos, all photos, individual photo albums, all photo albums, etc. The selections may be implemented in a variety of ways. For example, system 102 may cause buttons or check boxes to be displayed next to various selections. In some implementations, system 102 enables users of the social network to specify and/or consent to the use of using their photos for facial recognition in general. Example implementations for recognizing faces and other objects are described in more detail below.

In various implementations, system 102 obtains reference images of users of the social network system, where each reference image includes an image of a face that is associated with a known user. The user is known, in that system 102 has the user's identity information such as the user's name and other profile information. In some implementations, a reference image may be, for example, a profile image that the user has uploaded. In some implementations, a reference image may be based on a composite of a group of reference images.

In some implementations, to recognize a face or other object in a photo, system 102 may compare the face (e.g., image of the face) or other object, and match the face or other object to reference images of users of the social network system. Note that the term “face” and the phrase “image of the face” are used interchangeably. For ease of illustration, the recognition of one face is described in some of the example implementations described herein. These implementations may also apply to each face of multiple faces to be recognized.

In some implementations, system 102 may search reference images in order to identify any one or more reference images that are similar to the face or other object in the photo. In some implementations, for a given reference image, system 102 may extract features from the image of the face or other object in a photo for analysis, and then compare those features to those of one or more reference images. For example, system 102 may analyze the relative position, size, and/or shape of object features (e.g., eyes, nose, cheekbones, mouth, jaw, etc). In some implementations, system 102 may use data gathered from the analysis to match the face or other object in the photo to one more reference images with matching or similar features. In some implementations, system 102 may normalize multiple reference images, and compress data from those images into a composite representation having information (e.g., feature data), and then compare the face in the photo to the composite representation for recognition.

Implementations described herein provide various benefits. For example, implementations described herein increase overall engagement among users in a social networking environment. Implementations enable photos that people take to be conveniently shared, especially after being automatically backed up online. When users post content that is related to places that other users (e.g., friends and other relevant socially connected people) have been, implementations generate a signal identifying user connections to such places based on the geotags of photos. This may have a tremendous impact on the ability for friends to share memories and photos of their trips and other activities. As described above, implementations may cause the user interface to identify and display suggestions right inside the activity feed and increase overall engagement among users.

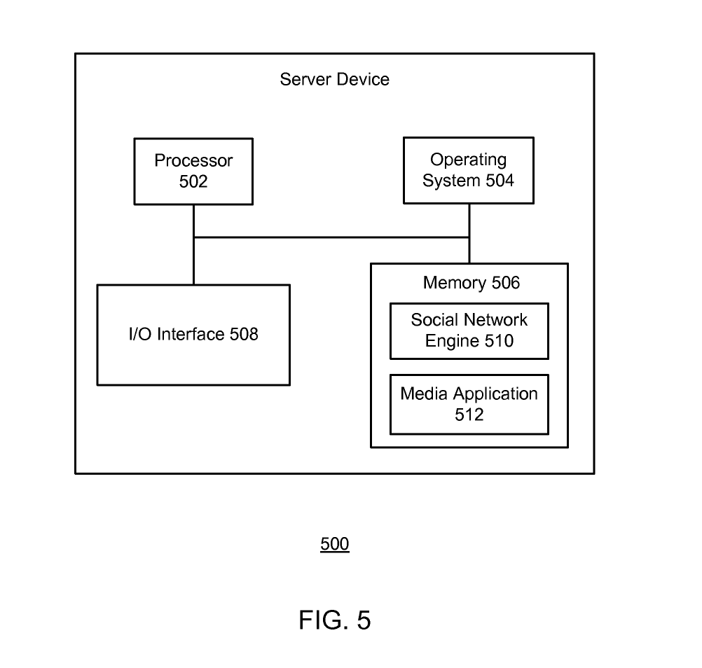

FIG. 5 illustrates a block diagram of an example server device 500, which may be used to implement the implementations described herein. For example, server device 500 may be used to implement server device 104 of FIG. 1, as well as to perform the method implementations described herein. In some implementations, server device 500 includes a processor 502, an operating system 504, a memory 506, and an input/output (I/O) interface 508. Server device 500 also includes a social network engine 510 and a media application 512, which may be stored in memory 506 or on any other suitable storage location or computer-readable medium. Media application 512 provides instructions that enable processor 502 to perform the functions described herein and other functions.

For ease of illustration, FIG. 5 shows one block for each of processor 502, operating system 504, memory 506, I/O interface 508, social network engine 510, and media application 512. These blocks 502, 504, 506, 508, 510, and 512 may represent multiple processors, operating systems, memories, I/O interfaces, social network engines, and media applications. In other implementations, server device 500 may not have all of the components shown and/or may have other elements including other types of elements instead of, or in addition to, those shown herein.

Although the description has been described with respect to particular embodiments thereof, these particular embodiments are merely illustrative, and not restrictive. Concepts illustrated in the examples may be applied to other examples and implementations.

Note that the functional blocks, methods, devices, and systems described in the present disclosure may be integrated or divided into different combinations of systems, devices, and functional blocks as would be known to those skilled in the art.

Any suitable programming languages and programming techniques may be used to implement the routines of particular embodiments. Different programming techniques may be employed such as procedural or object-oriented. The routines may execute on a single processing device or multiple processors. Although the steps, operations, or computations may be presented in a specific order, the order may be changed in different particular embodiments. In some particular embodiments, multiple steps shown as sequential in this specification may be performed at the same time.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

What is claimed is:

1. A method comprising:
receiving one or more media items in a social network, wherein the one or more media items are associated with a location;
detecting a post, wherein content in the post references the location;
analyzing the content in the post;
identifying a reference to the location in the content in the post; and
providing a suggestion to a user to share the one or more media items in the post, wherein the providing of the suggestion is based on predetermined criteria.

2. The method of claim 1, wherein the one or more media items include one or more of photos, images, graphics, videos, and audio tracks.

3. The method of claim 1, wherein the one or more media items are associated with the location by geotags.

4. The method of claim 1, wherein the providing of the suggestion comprises:
providing a prompt to share the one or more media items;
causing the one or more media items to be displayed to the user; and
enabling the user to select the one or more media items to include in the post.

5. A method comprising:
receiving one or more media items in a social network, wherein the one or more media items are associated with a location;
detecting a post, wherein content in the post references the location; and
providing a suggestion to a user to share the one or more media items in the post.

6. The method of claim 5, wherein the one or more media items include one or more of photos, images, graphics, videos, and audio tracks.

7. The method of claim 5, wherein the one or more media items are associated with the location by geotags.

8. The method of claim 5, wherein the location is a business location.

9. The method of claim 5, further comprising:
analyzing the content in the post; and
identifying a reference to the location in the content in the post.

10. The method of claim 5, wherein the providing of the suggestion comprises:
providing a prompt to share the one or more media items;
causing the one or more media items to be displayed to the user; and
enabling the user to select the one or more media items to include in the post.

11. The method of claim 5, wherein the providing of the suggestion is based on predetermined criteria.

12. The method of claim 5, wherein the providing of the suggestion is based on predetermined criteria associated with geographic radius.

13. The method of claim 5, wherein the providing of the suggestion is based on predetermined criteria associated with one or more social signals.

14. The method of claim 5, wherein the providing of the suggestion is based on predetermined ranking criteria.

15. The method of claim 5, wherein the providing of the suggestion is based on predetermined image recognition criteria.

16. A system comprising:
one or more processors; and
logic encoded in one or more tangible media for execution by the one or more processors and when executed operable to perform operations comprising:
receiving one or more media items in a social network, wherein the one or more media items are associated with a location;
detecting a post, wherein content in the post references the location; and
providing a suggestion to a user to share the one or more media items in the post.

17. The system of claim 16, wherein the one or more media items include one or more of photos, images, graphics, videos, and audio tracks.

18. The system of claim 16, wherein the one or more media items are associated with the location by geotags.

19. The system of claim 16, wherein the location is a business location.

20. The system of claim 16, wherein the logic when executed is further operable to perform operations comprising:
analyzing the content in the post; and
identifying a reference to the location in the content in the post.
